(19) United States
(12) Patent Application Publication
(10) Pub. No.: US 2025/0280876 A1
(43) Pub. Date: Sep. 11, 2025

(54) ATOMIZER AND AEROSOL GENERATING APPARATUS

(71) Applicant: Shenzhen Woody Vapes Technology Co., Ltd., Shenzhen (CN)

(72) Inventors: Zupeng HU, Shenzhen (CN); Jialong SHANG, Shenzhen (CN); Ying CHENG, Shenzhen (CN); Lijun CHEN, Shenzhen (CN)

(73) Assignee: Shenzhen Woody Vapes Technology Co., Ltd., Shenzhen (CN)

(21) Appl. No.: 18/898,931

(22) Filed: Sep. 27, 2024

(30) Foreign Application Priority Data
Mar. 7, 2024 (CN) 202420459708.2

(51) Int. Cl. A24F 40/44; A24F 40/10; A24F 40/42; A24F 40/46; A24F 40/485; F16J 15/10

(52) U.S. Cl. CPC A24F 40/44; A24F 40/10; A24F 40/42; A24F 40/46; A24F 40/485; F16J 15/104

(57) ABSTRACT

An atomizer includes: a liquid cup provided with a cup mouth and a mist outlet, a liquid storage tank being provided in the liquid cup; an atomization assembly including an atomization tube, a liquid guide part, and a heating part disposed inside the liquid guide part, the atomization tube being sleeved on an outer peripheral side of the liquid guide part and connected with the mist outlet and being provided with a liquid inlet so that the liquid guide part is connected with the liquid storage tank; and a base assembly including a base and a sealing member, the sealing member including a protrusion extending toward the mist outlet to be inserted into an end of the liquid guide part, the sealing member fitting with at least part of an inner wall of the liquid guide part to seal an inner side of the liquid guide part.

### CROSS-REFERENCE TO RELATED APPLICATION

This application claims the priority to Chinese Patent Application No. 202420459708.2, filed on Mar. 7, 2024. The disclosure of the abovementioned application is incorporated herein by reference in its entirety.

### TECHNICAL FIELD

The present disclosure relates to atomization technologies, and more particularly relates to an atomizer and an aerosol generating apparatus.

### BACKGROUND

An atomizer is a part of the aerosol generating apparatus for generating aerosol, and therefore is provided with an atomization assembly for atomizing liquid and mixing the atomized liquid with gas to generate aerosol for use by a user. Specifically, a liquid guide and a heating part are installed in the atomization assembly. The liquid guide is connected with a liquid storage tank, and the liquid in the liquid storage tank can be dispersed onto the liquid guide through capillary action. The heating part is disposed in the liquid guide and thus may also be in contact with the liquid. The liquid in contact with heating part may be atomized by the heating part through heating and then mixed with gas to generate aerosol. The liquid guide serves as an intermediate medium connecting the liquid storage tank with the heating part.

If the heating part is directly connected with the liquid storage tank, the liquid may leak directly from the heating part into the mist outlet passage, which may bring the liquid into contact with an electronic device in the aerosol generating apparatus, thereby causing damage to the electronic device. As a result, the liquid guide not only functions to guide the liquid, but also blocks the flow of the liquid to a certain extent, thereby preventing the liquid from breaking through the surface of the liquid guide to flow into the mist outlet passage.

On the other hand, there are higher and higher requirements for the liquid storage capacity of an atomizer since it is necessary to store a large amount of liquid in order to provide aerosol with many functions. However, a large amount of liquid in the liquid storage tank will have high pressure on the liquid guide, so that the liquid guide may be often broken through by the liquid, thereby resulting in liquid leakage. Thus, there is a need for a better sealed atomizer in order to avoid damage to the electronic device in the aerosol generating apparatus.

### SUMMARY

According to one or more embodiments of the present disclosure, an atomizer includes: a liquid cup having a first end provided with a cup mouth and a second end provided with a mist outlet, a liquid storage tank being provided in the liquid cup; an atomization assembly comprising an atomization tube, a liquid guide part, and a heating part disposed in the liquid guide part, the atomization tube being sleeved on an outer peripheral side of the liquid guide part and connected with the mist outlet, the atomization tube being provided with one or more liquid inlets so that the liquid guide part is connected with the liquid storage tank; and a base assembly comprising a base and a sealing member disposed on the base, the sealing member comprising a protrusion extending toward the mist outlet so as to be connected to an end of the liquid guide part away from the mist outlet, the sealing member fitting with at least part of an inner wall of the liquid guide part to seal an inner side of the liquid guide part.

According to one or more embodiments of the present disclosure, an aerosol generating apparatus includes the atomizer mentioned above.

### BRIEF DESCRIPTION OF THE DRAWINGS

FIG. 1 is a schematic cross-sectional view of an example of an atomizer according to one or more embodiments of the present disclosure.

FIG. 2 is an enlarged view of part C in FIG. 1.

FIG. 3 is a schematic cross-sectional view of the atomizer from another perspective.

FIG. 4 is an enlarged view of part D in FIG. 3.

FIG. 5 is a schematic structural diagram of an example of a sealing member according to one or more embodiments of the present disclosure.

FIG. 6 is a schematic structural diagram of the sealing member as shown in FIG. 5 from another perspective.

FIG. 7 is a schematic structural diagram of another example of a sealing member according to one or more embodiments of the present disclosure.

FIG. 8 is a schematic cross-sectional view of another example of an atomizer according to one or more embodiments of the present disclosure.

FIG. 9 is an enlarged view of part E in FIG. 8.

FIG. 10 is a schematic cross-sectional view of the atomizer as shown in FIG. 8 from another perspective.

FIG. 11 is a schematic exploded view of the atomizer.

FIG. 12 is an enlarged view of part F in FIG. 11.

FIG. 13 is a structural diagram of the atomizer in an intermediate state during the assembly process based on an example.

FIG. 14 is a structural diagram of the atomizer in an intermediate state during the assembly process based on another example.

### DETAILED DESCRIPTION

Some embodiments of the present disclosure will be described in detail below with reference to the accompanying drawings. The embodiments are described for illustrative purposes only and are not intended to limit the present disclosure.

An atomizer provided by one or more embodiments of the present disclosure may be applied to an aerosol generating apparatus. The aerosol generating apparatus may include the atomizer and a body having a mechanism such as a control mechanism and a power supply mechanism. When the atomizer is connected to the body of the aerosol generating apparatus, the power supply mechanism in the body supplies power to the atomizer so that the power supply mechanism may supply power to the atomization assembly of the atomizer to generate heat. The specific method in which the atomization assembly generates heat is determined by the type of the atomization assembly. For example, when a structure such as an electric heating wire is included in the atomization assembly, current is directly supplied to the atomization assembly to heat the electric heating wire. When the atomization assembly is a conductor, a changing magnetic field may be supplied to the atomization assembly to excite the atomization assembly to generate a vortex current to generate heat. The control assembly in the body of the aerosol generating apparatus may also be provided with a breath detector. When the atomizer is connected to the body, the breath detector may be connected with the mist outlet tube, so that the breath detector may detect the gas flow in the mist outlet tube, thereby controlling the power supply mechanism to supply electric power corresponding to the gas flow in the mist outlet tube to the atomization assembly.

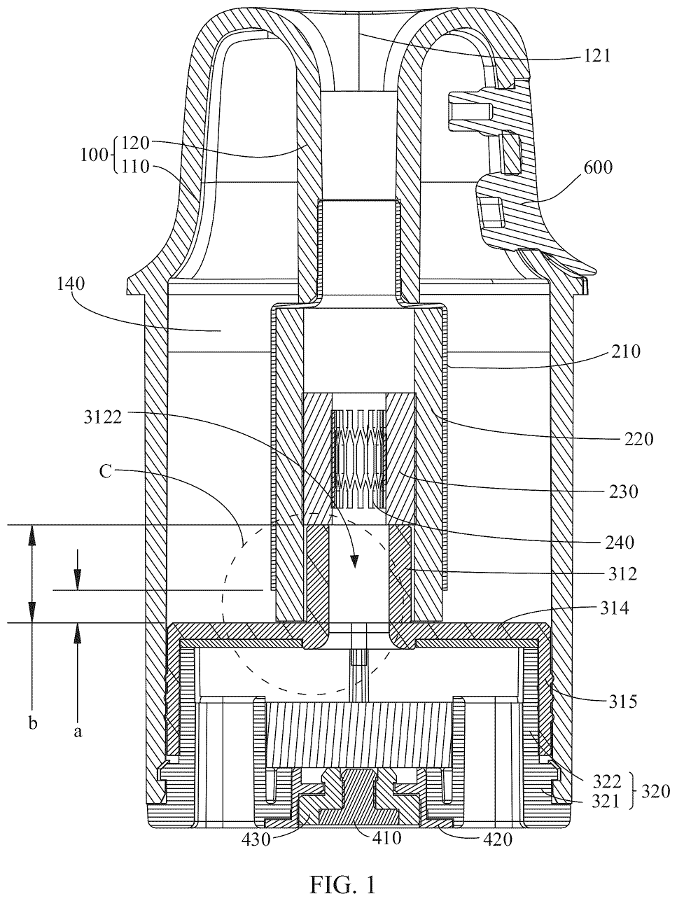

As shown in FIG. 1, one or more embodiments of the present disclosure provides an atomizer including a liquid cup 100, an atomization assembly 200, and a base assembly 300. The liquid cup 100 has an end provided with a cup mouth, and another opposite end is provided with a mist outlet 121. A liquid storage tank 140 is provided in the liquid cup 100. The atomization assembly 200 includes an atomization tube 210, a liquid guide, and a heating part 240. The heating part 240 is provided in the liquid guide, the atomization tube 210 is connected with the mist outlet 121 and is sleeved on the outer peripheral side of the liquid guide, and the atomization tube 210 is provided with a liquid inlet 211, so that the liquid guide is connected with the liquid storage tank 140. The base assembly 300 includes a base 320 and a sealing member 310. The base 320 covers the cup mouth. The sealing member 310 is installed to the base 320 and extends along a side close to the mist outlet 121 so as to be connected to an end of the liquid guide away from the mist outlet 121 by insertion. The sealing member 310, the atomization tube 210 and the mist outlet 121 are connected to form a mist outlet passage. The sealing member 310 fits with at least part of the inner wall of the liquid guide to block the radially inner side of the liquid guide. The liquid is guided by the liquid guide from the liquid storage tank 140 to the heating part 240 through capillary action. Thus, the liquid is normally filled in the liquid guide. However, the amount of the liquid is not evenly distributed in the liquid guide. The liquid tends to accumulate towards the direction of gravity. While the atomizer is generally approximately in the upright position as shown in FIG. 1, that is, the direction of the gas flow in the mist outlet passage is approximately anti-gravity. Thus, the liquid generally accumulates at the end of the liquid guide facing the base 320. Therefore, the sealing member 310 fits at least a part of the inner wall the liquid guide to block the radially inner side of the liquid guide, so that the sealing may be improved and the liquid leakage is prevented. In addition, the sealing member 310 may abut against or be spaced apart from the inner wall of the liquid guide. Since the liquid has a large surface tension, even if the sealing member 310 is spaced apart from the inner wall of the liquid guide, the liquid may be greatly hindered from flowing inwardly in the radial direction of the liquid guide.

As shown in FIG. 1, in one or more embodiments, the sealing member 310 includes a protrusion 312 extending in the direction of the mist outlet, and sealing member 310 further includes a support part 314 connected to the protrusion and installed on the base. The support part 314 abuts against the inner wall of the liquid cup 100, so that the support part 314, the liquid cup 100 and the atomization tube 210 form the liquid storage tank 140. The protrusion 312 has an end extending through the support part 314 and another opposite end extending toward the mist outlet 121 so as to be connected to the inner side of the end of the liquid guide away from the mist outlet 121 by insertion. Thus, the end face of the sealing member 310 facing the base 320 is located in the liquid storage tank 140, and there is no need for blocking or there is no leakage therefrom. The support part 314 also improves the sealing effect of the liquid storage tank 140, and liquid is prevented from leaking directly from the fit clearance between the base assembly 300 and the liquid cup 100.

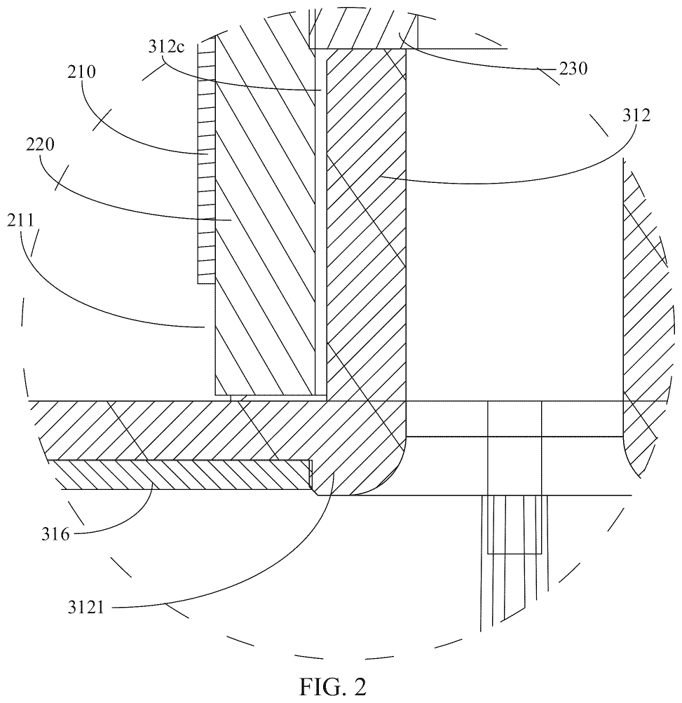

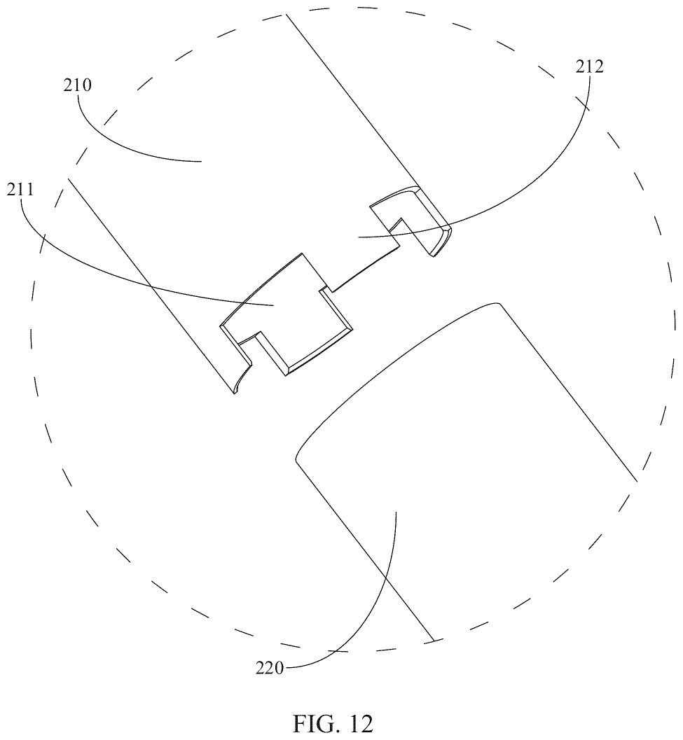

As shown in FIG. 12, in one or more embodiments, an end of the atomization tube 210 close to the support part 314 is provided with multiple abutments 212 protruding axially along the atomization tube 210 and abutting the support part 314. In this way, the support part 314 may provide support to the end of the atomization tube 210 close to the support part 314, thereby improving the fixing effect of the atomization assembly 200. The multiple abutments 212 are provided at intervals to form multiple liquid inlets 211 arranged at equal intervals in the circumferential direction of the atomization tube 210. Thus, the liquid may enter the liquid guide in all directions, thereby improving the liquid supply capacity of the aerosol generating apparatus. As shown in FIG. 2, in another one or more embodiments, the end of the atomization tube 210 close to the support part 314 is spaced apart from the support part 314 to form the liquid inlet 211. This has a simple structure and simplifies the manufacture of the atomization tube 210. Also, the length of the liquid inlet 211 in the circumferential direction of the atomization tube 210 is maximized (i.e., equal to the circumferential length of the atomization tube 210), so that the liquid may enter the liquid guide from all directions, thereby improving the liquid supply capacity.

As shown in FIG. 1, in one or more embodiments, the sealing member 310 further includes a first extension part 315. The first extension part 315 is provided on the peripheral side of the support part 314 and extends away from the liquid storage tank 140. The outer peripheral side of the first extension part 315 abuts against the inner wall of the liquid cup 100. In this way, when breaking through the fit clearance between the support part 314 and the inner wall of the liquid cup 100, the liquid is blocked by the first extension part 315, thereby improving the sealing effect of the liquid storage tank 140.

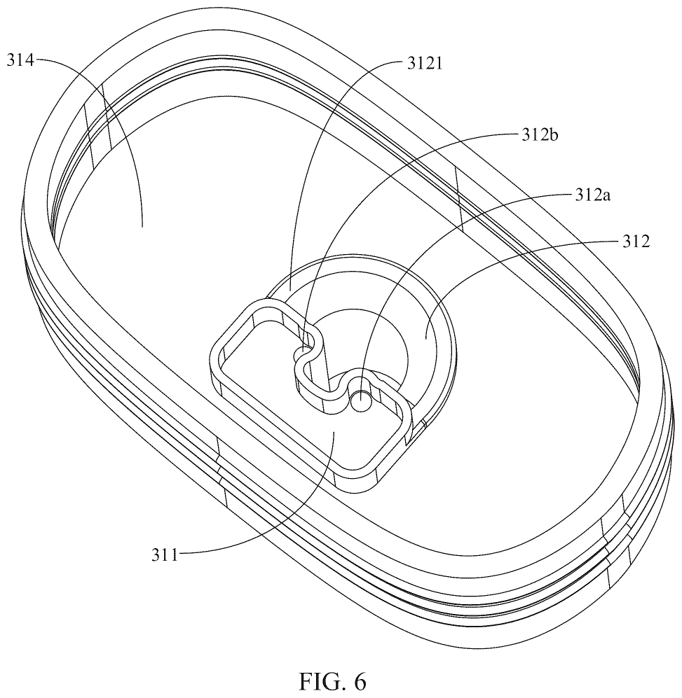

In one or more embodiments, the protrusion 312 extends through the reinforcing sheet 316 and protrudes out of the side of the reinforcing sheet 316 away from the support part 314. That is, as shown in FIGS. 2 and 6, since the protrusion 312 protrudes out of the side of the reinforcing sheet 316 away from the support part 314, the end of the protrusion 312 protruding out of the reinforcing sheet 316 forms a liquid collection ring 3121. If condensate droplets flow toward the base 320 along the inner side wall of the protrusion 312 during the operation of the atomizer, they will eventually converge onto the liquid collection ring 3121 and are not likely to flow further outwardly in the radial direction of the protrusion 312 onto the reinforcing sheet 316. The condensate is thus controllable. Specifically, when the condensate reaches a certain amount, the droplets will fall. Since the droplets are hung on the liquid collection ring 3121, the position of the falling is substantially at the projection of the liquid collection ring 3121 on the base 320. A leakage passage or a structure such as a liquid absorbing member 500 mentioned below may be provided at the position to discharge the condensed liquid out of the atomizer or absorb the condensed liquid into the liquid absorbing member 500, so as to prevent the condensed liquid from flowing to other devices to cause damage. For example, a common danger of condensate is that it will flow to the breath detector in the aerosol generating apparatus to damage the breath detector.

As shown in FIG. 1, in one or more embodiments, the base 320 includes a cover 321 and a second extension part 322. The cover 321 covers the cup mouth of the liquid cup 100, and the second extension part 322 surrounds the cover 321 and extends toward the support part 314. The outer peripheral side of the second extension 322 abuts against the first extension part 315, so that the first extension part 315 may better abut against the inner wall of the liquid cup 100, thereby improving the sealing effect. The end face of the second extension part 322 away from the cover 321 may abut against the reinforcing sheet 316. In this way, the reinforcing sheet 316 may be supported to improve the fixing effect of the reinforcing sheet 316.

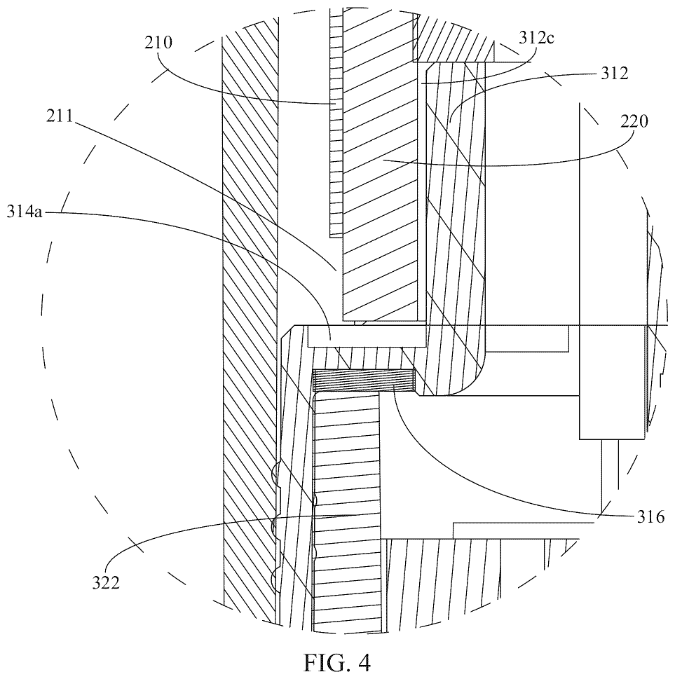

As shown in FIG. 4, in one or more embodiments, a gas release groove 314a is provided on the side of the support part 314 facing the liquid storage tank 140. The gas release groove 314a extends away from the protrusion 312 in the radial direction of the protrusion 312 from the connection position between the protrusion 312 and the support part 314. The gas release groove 314a is connected with the liquid storage tank 140. In this way, the gas release groove 314a may supply gas to the liquid storage tank 140 through the second gap between the liquid guide and the protrusion 312, so that the liquid is prevented from failing to be transported to the heating part 240 through the liquid guide due to the negative pressure caused by the consumption of the liquid in the liquid storage tank 140.

As shown in FIG. 1, in one or more embodiments, the liquid guide includes a first liquid guide 220 and a second liquid guide 230. The atomization tube 210 is sleeved on the outer peripheral side of the first liquid guide 220. The first liquid guide 220 is sleeved on the outer peripheral side of the second guide 230. The heating part 240 is disposed in the second liquid guide 230. The radially outer peripheral side of the protrusion 312 abuts against the radially inner peripheral side of the first liquid guide 220. The end face of the protrusion 312 away from the support part 314 abuts against the end face of the second liquid guide 230. In this way, the radially inner side of the first liquid guide 220 and the end face of the second guide 230 facing the protrusion 312 are both blocked, thereby improving the sealing effect of the liquid.

The atomizer is a part of the aerosol generating apparatus to generate aerosol, and therefore is provided with an atomization assembly for atomizing the liquid and mixing the atomized liquid with gas to generate aerosol for use by a user. In a general atomizer, the atomization assembly is usually directly installed in the mist outlet tube, which is then installed with the liquid cup by means of bonding or fastening. On the one hand, the space in the atomization tube is narrow, so that the atomization assembly is difficult to install in place. On the other hand, the mist outlet tube needs to extend through the liquid cup to fit the installation structure at the surface of the liquid cup, which requires the length of the mist outlet tube extending to be great, so that assembly is difficult. It can be seen that the general atomizer is difficult to assemble, which leads to low efficiency and poor consistency in atomizer assembly. In order to make the atomizer assembly more efficient and consistent, there is a need for an atomizer that is more convenient to assemble.

According to the atomizer provided in one or more embodiments of the present disclosure, a mist outlet tube is provided on the liquid cup, one end of the atomizer assembly is connected to one end of the mist outlet tube away from the mist outlet, and another end of the atomizer assembly is connected to the protrusion of the base assembly, so that the atomizer may be assembled more conveniently. Specifically, when the mist tube and the housing are integrated, the problem of connecting the mist outlet tube to the housing does not need to be taken into account when assembling, thereby making the assembly easier. When the mist outlet tube and the housing are separated, since the atomization assembly is not disposed in the mist outlet tube, but is connected to the end of the mist outlet tube away from the mist outlet, the atomization tube does not need to extend to the base assembly independently, but may be extended to the base assembly through the atomization assembly. Thus, the length of the atomization tube is small and the assembly difficulty is small. In addition, the atomization core is connected to each of the mist outlet tube and the base assembly by insertion, so that the atomization core does not need operations such as rotation (if a threaded connection is used, rotation is usually required) when being assembled to the mist outlet tube, and the atomization core only needs to be pushed toward the mist outlet tube in the insertion direction. Similarly, the base assembly may also only need to be pushed toward the atomization core in the insertion direction so as to be connected, and the assembly process is more convenient. In summary, according to the aerosol generating apparatus provided in one or more embodiments of the present disclosure, the assembly of the aerosol generating apparatus may be more convenient.

As shown in FIG. 1, an atomizer according to one or more embodiments of the present disclosure includes a liquid cup 100, an atomization assembly 200, and a base assembly 300. The liquid cup 100 may include a housing 110 and a mist outlet tube 120 having one end provided with a mist outlet 121. The end of the mist outlet tube 120 provided with the mist outlet 121 is connected to the housing. The atomization assembly may include a first end and a second end opposite to the first end. The first end of the atomization assembly is connected to an end of the mist outlet tube 120 away from the mist outlet 121. The base assembly includes the protrusion 312 and the support part connected to the protrusion 312. The protrusion 312 is connected to the second end of the atomization assembly 200, and an end of the support part away from the protrusion is connected to an end of the housing away from the mist outlet 121. The protrusion 312 may have a material such as silica gel, rubber, or the like. In one or more embodiments, the protrusion 312 may also be provided with a gas flow passage 3122 connected with outside. Thus, the outside and the gas path of the atomization assembly can be connected.

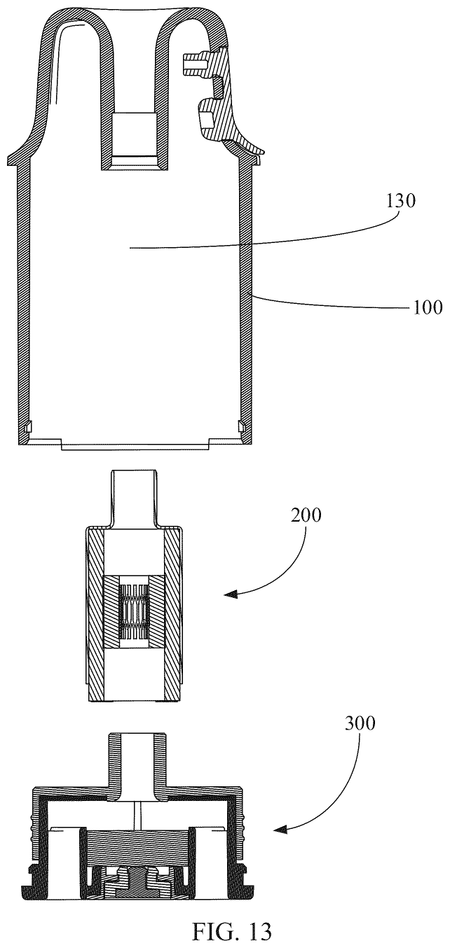

Specifically, as shown in FIG. 13, in one or more embodiments, an installation chamber 130 is provided in the housing 110. The housing 110 is further provided with a cup mouth and an installation cup mouth both connected with the installation chamber 130, and the mist outlet tube 120 is provided in the installation chamber 130. An end of the mist outlet tube 120 is installed to the installation cup mouth and provided with the mist outlet 121, and the other end of the mist outlet tube 120 extends toward the cup mouth. In practice, in one or more embodiments without the mist outlet tube 120, the installation cup mouth may directly serve as the mist outlet 121. As shown in FIG. 1, the edge of the installation cup mouth and the edge of the mist outlet 121 are connected to each other, so that the mist outlet tube 120 and the housing 110 may be integrated, or the mist outlet tube 120 may be separately formed and then connected to the housing 110 by means of bonding or fastening. An end of the atomization assembly 200 is connected to the mist outlet tube 120 by insertion. As shown in FIG. 1, the atomization tube 210 of the atomization assembly 200 may be inserted into the mist outlet tube 120. However, the mist outlet tube 120 may be inserted into the atomization tube 210 of the atomization assembly 200 or into the liquid guide of the atomization assembly 200. An end of the base assembly 300 close to the mist outlet tube 120 is connected to an end of the atomization assembly 200 away from the mist outlet tube 120 by insertion. Similarly, as shown in FIG. 1, the base assembly 300 may be provided with a protrusion 312. The protrusion 312 is inserted into the liquid guide or the atomization tube 210 of the atomization assembly 200 is inserted into the base assembly 300. The base assembly 300 covers the cup mouth so that the structure in the installation chamber 130 can be enclosed.

As shown in FIG. 1, it can be seen that, on the one hand, the atomization assembly 200 does not need to be installed in the mist outlet tube 120 (generally, the atomization assembly 200 is installed in the mist outlet tube 120), but is simply connected to the mist outlet tube 120 by insertion, so that it is not necessary to install the atomization assembly 200 in the mist outlet tube 120 with a narrow space. It is difficult to install the atomization component 200 in a preset position inside the mist outlet tube 120, which makes the assembly difficult, thereby causing low assembling efficiency and poor consistency. On the other hand, the length of the mist outlet tube 120 is shortened. This is because if the atomization assembly 200 is installed in the mist outlet tube 120, the end of the mist outlet tube 120 away from the mist outlet 121 has to extend to the base assembly 300. This makes it simpler to assemble even if the mist outlet tube 120 and the housing 110 are separated and need to be assembled. This is because if the mist outlet tube 120 is longer, the installation deviation of the end of the mist outlet 120 away from the mist outlet 121 will be amplified more when the installation deviation of the end of the mist outlet tube 120 at the installation cup mouth is the same. In addition, since the atomization assembly 200 is connected to each of the mist outlet tube 120 and the base assembly 300 by insertion, the atomization assembly 200 and the base assembly 300 may be assembled first, and then the atomization assembly 200 is connected to the mist outlet tube 120, by insertion, and then the base assembly 300 is connected to the atomization assembly 200 by insertion to complete installation. The assembly is modular and more convenient (for details, reference may be made to the contents of the assembling method of the atomizer hereinafter).

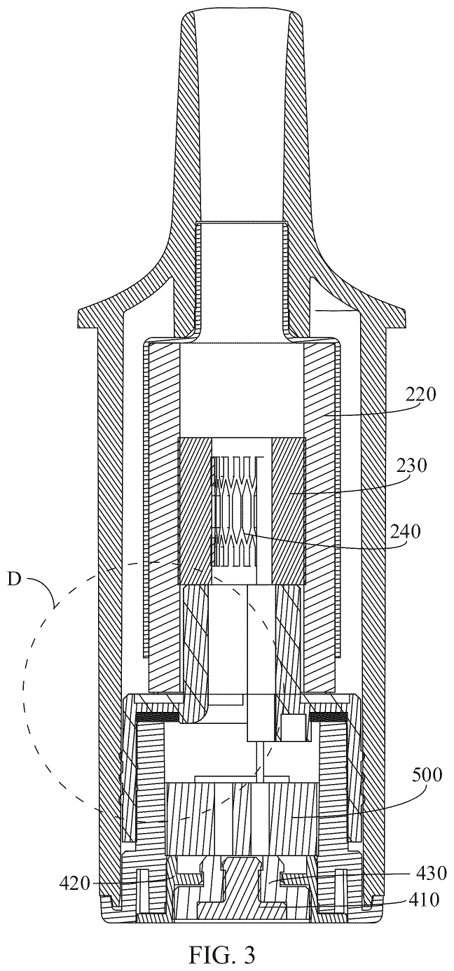

As shown in FIG. 1, in one or more embodiments, an atomization assembly 200 includes the atomization tube 210, the liquid guide, and a heating part 240. The heating part 240 is disposed on the inner side of the liquid guide, and the liquid guide includes a first liquid guide 220 and a second liquid guide 230, that is, as shown in FIG. 3, the heating part 240 may be disposed on the inner peripheral side of the second liquid guide 230. In another one or more embodiments, the second liquid guide 230 may surround the heating part 240, or when the second liquid guide 230 is not provided and only the first liquid guide 220 is provided, the atomization assembly 200 may be disposed on the inner peripheral side of the first liquid guide 220 or surrounded by the first liquid guide 220. The atomization tube 210 is sleeved on the outer peripheral side of the liquid guide. The atomization tube 210 is connected to an end of the mist outlet tube 120 away from the mist outlet 121 by insertion so as to be connected with the mist outlet tube 120. An end of the base assembly 300 close to the mist outlet tube 120 is connected to an end of the liquid guide away from the mist outlet tube 120 and fits the inner peripheral side of the end of the liquid guide away from the mist outlet tube 120. This may improve the sealing of the atomizer, that is, prevent the leakage of liquid from the liquid storage tank 140 through the atomization assembly 200. In particular, the liquid is guided from the liquid storage tank 140 and dispersed throughout the atomization assembly 200 by the liquid guide through capillary action. Since being disposed in the liquid guide, the heating part 240 is in contact with the liquid on the liquid guide, and when the heating part 240 heats up, the liquid is atomized and mixed with gas to generate aerosol which is finally discharged from the mist outlet 121 for use by a user. The distribution of the liquid in the liquid guide is not completely uniform, since under the action of gravity the liquid tends to accumulate towards the direction in which the gravity is directed. Thus, if the atomizer is placed upright as shown in FIG. 3, in one or more embodiments, the liquid tends to accumulate in the direction of the liquid guide close to the support part 314. Therefore, it is easy for the liquid accumulated at the position in the liquid guide close to the support part 314 to break through the limit of the liquid guide and flows out of the liquid guide. However, since an end of the base assembly 300 close to the mist outlet tube 120 is connected to an end of the liquid guide away from the mist outlet tube 120 by insertion and fits the inner peripheral side of the end of the mist outlet tube 120 away from the mist outlet tube 120, it just hinders the liquid from flowing out of the position in the liquid guide close to the support part 314, thereby improving the sealing of the atomizer. As shown in FIG. 4, a part of the base assembly 300 inserted into the mist outlet tube 120 may be a protrusion 312, which may be tubular. In another one or more embodiments, the protrusion 312 may have other irregular shapes. In addition, it should be noted that since the atomizer and the aerosol generating apparatus are often portable in actual use, they are inevitably placed in various postures by the user. Thus, in many cases, the atomizer is not in the upright position as shown in FIG. 3, but may be on its side or even upside down. However, when the atomizer is used by the user, it is usually placed in an upright position similar to that shown in FIG. 3, because when the user suctioning the aerosol, the user tends to lower its head, rather than lift its head, to suction the aerosol. When the aerosol is suctioned by the user, a large amount of the liquid in the liquid guide is consumed to become atomized mist, mixed with gas to form the aerosol, and then discharged from the mist outlet 121. As a result, liquid is constantly replenished from the liquid storage tank 140 to the liquid guide, so that the liquid flow on the liquid guide is the most intense during the use of the user, thereby easily causing the liquid to overflow the liquid guide. Thus, when the atomizer is at the upright position shown in FIG. 3 (that is, at the position, the mist outlet direction of the atomizer and the direction of gravity are approximately opposite), the end of the liquid guide close to the support part 314 is blocked, that is, the sealing effect of the atomizer may be greatly improved. The part of the base assembly 300 inserted into the liquid guide may fit the inner peripheral side of the liquid guide through an interference fit or an at least partial clearance fit. This is because the surface tension of the liquid is large, and even if there is an at least partial clearance fit, a blocking effect can be achieved. The fit method may be selected based on actual conditions.

As shown in FIG. 1, in one or more embodiments, the base assembly 300 includes the protrusion 312 having an end extending toward the mist outlet tube 120 for being connected to an end of the liquid guide away from the mist outlet tube 120 by insertion, and a support part 314. The protrusion 312 may include a soft rubber material, such as silica gel or rubber, to improve the sealing effect. However, the protrusion 312 may include a plastic material, a metal material, or the like, to improve the support for the atomization assembly 200, and also have a certain sealing effect. The support part 314 surrounds an end of the protrusion 312 away from the mist outlet tube 120, and the side edge of the support part 314 away from the protrusion 312 abuts against the inner wall of the liquid cup 100, so that the support part 314, the liquid cup 100, the mist outlet tube 120, and the atomization tube 210 form the liquid storage tank 140. The support part 314 may be made of a soft rubber material same as the protrusion 312, so that the sealing effect of the liquid storage tank 140 may be improved. The liquid in the liquid storage tank 140 is prevented from leaking out of the liquid storage tank 140 through the fit clearance between the support part 314 and the inner wall of the liquid cup 100. The support part 314 surrounds the end of the protrusion 312 away from the mist outlet tube 120, and it may be understood that the protrusion 312 extends through the support part 314. The protrusion 312 and the support part 314 may be integrated so that there is no fit clearance between the protrusion 312 and the support part 314, thereby preventing liquid from leaking out of the liquid storage tank 140 through the fit clearance between the protrusion 312 and the support part 314. However, the protrusion 312 and the support part 314 may also be provided separately in one or more embodiments, as described below.

As shown in FIG. 1, in one or more embodiments, the liquid guide includes the first liquid guide 220 and the second liquid guide 230. The first liquid guide 220 and the second guide 230 are both tubular in shape. The first liquid guide 220 may include a fiber material, a porous body, or the like. The fiber material may be a plant fiber, an animal fiber, a mineral fiber, a synthetic fiber, or the like. The material of the first liquid guide 220 may be cotton, non-woven fabric, glass fiber material, porous ceramic material, porous metal material, or the like. The material of the second liquid guide 230 may be a fiber material, a porous body, or the like. The fiber material may be a plant fiber, an animal fiber, a mineral fiber, a synthetic fiber, or the like. The material of the second liquid guide 230 may be cotton, non-woven cloth, glass fiber material, porous ceramic material, porous metal material, or the like. The atomization tube 210 is sleeved on the outer peripheral side of the first liquid guide 220, the first liquid guide 220 is sleeved on the outer peripheral side of the second liquid guide 230, and the heating part 240 is disposed in the second liquid guide 230. In this way, it is necessary for the liquid to pass through the first liquid guide 220 to enter the second liquid guide 230 so as to be in contact with the heating part 240, thereby extending the distance of the liquid path, increasing the blocking effect of the liquid guide on the liquid, and reducing the risk of the liquid breaking through the surface of the liquid guide (especially the second liquid guide 230) to flow out. An end of the base assembly 300 close to the mist outlet tube 120 is connected to an end of the first liquid guide 220 away from the mist outlet tube 120 by insertion, and an end face of the base assembly 300 close to the mist outlet tube 120 at least partially abuts against an end face of the second liquid guide 230. In this way, when the atomizer is used by the user, the lower end of the second liquid guide 230 in the gravity direction may be blocked, so that the liquid is prevented from breaking through the surface of the second liquid guide 230 at the position to leak out, and the sealing effect of the liquid is improved. Also, the second liquid guide may be reinforced to prevent the second liquid guide from falling off and deforming, and the service life of the second liquid guide is extended.

As shown in FIG. 1, in one or more embodiments, the base assembly 300 further includes the first extension part 315. The first extension part 315 has an end connected to one side of the support part 314 close to the housing 110, and an opposite end extending away from the mist outlet tube 120, which is equivalent to providing a skirt for the support part 314. The outer peripheral side of the first extension part 315 abuts against the inner wall of the housing 110, so that the contact area between the support part 314 and the inner wall of the liquid cup 100 is expanded. Thus, when the liquid penetrates into the fit clearance between the support part 314 and the liquid cup 100 and breaks through the support part 314, the first extension part 315 also generates a sealing effect, thereby preventing leakage of the liquid and improving the sealing effect.

As shown in FIG. 2, in one or more embodiments, the base assembly 300 further includes a reinforcing sheet 316. The reinforcing sheet 316 is attached to one side of the support part 314 away from the liquid storage tank 140 to support the support part 314. The reinforcing sheet 316 may have a hardness greater than the support part 314, for example, the reinforcing sheet 316 may adopt a steel sheet or a hard plastic, and the support part 314 may adopt a soft rubber. The support part 314 may perform a good sealing effect, and the reinforcing sheet 316 prevents deformation of the support part 314. The deformation of the support part 314 may cause the support part 314 to be unable to abut against the inner wall of the liquid cup 100, thereby causing leakage. Therefore, the reinforcing sheet 316 indirectly improves the sealing effect.

As shown in FIGS. 2, 6, and 8, in one or more embodiments, for example, as shown in FIG. 2, the reinforcing sheet 316 surrounds an end of the protrusion 312 away from the mist outlet tube 120, and the protrusion 312 protrudes out of the side of the reinforcing sheet 316 away from the support part 314. That is, as shown in FIGS. 2 and 6, since the protrusion 312 protrudes out of the side of the reinforcing sheet 316 away from the support part 314, the end of the protrusion 312 protruding out of the reinforcing sheet 316 may form a liquid collection ring 3121. As shown in FIG. 2, the bottom of the liquid collection ring 3121 is lower than the bottom of the reinforcing sheet 316. In other words, the side of the liquid collection ring 3121 away from the second guide 230 is more protrusive with respect to the side of the reinforcing sheet 316 away from the second guide 230. The liquid collection ring 3121 may prevent the condensate from flowing into the position where the reinforcing sheet 316 is located, so that the sealing effect is better, and leakage is effectively prevented. If the condensate droplets flow toward the base 320 along the inner side wall of the protrusion 312 during the operation of the atomizer, they will eventually converge onto the liquid collection ring 3121 and are not likely to flow further outwardly in the radial direction of the protrusion 312 onto the reinforcing sheet 316. The condensate is thus controllable. Specifically, when the condensate reaches a certain amount, the droplets will fall. Since the droplets are hung on the liquid collection ring 3121, the position of the falling is substantially at the projection of the liquid collection ring 3121 on the base 320. A leakage passage or a structure such as a liquid absorbing member 500 mentioned below may be provided at the position to discharge the condensed liquid out of the atomizer or absorb the condensed liquid into the liquid absorbing member 500, so as to prevent the condensed liquid from flowing to other devices to cause damage. For example, a common danger of condensate is that it will flow to the breath detector in the aerosol generating apparatus to damage the breath detector.

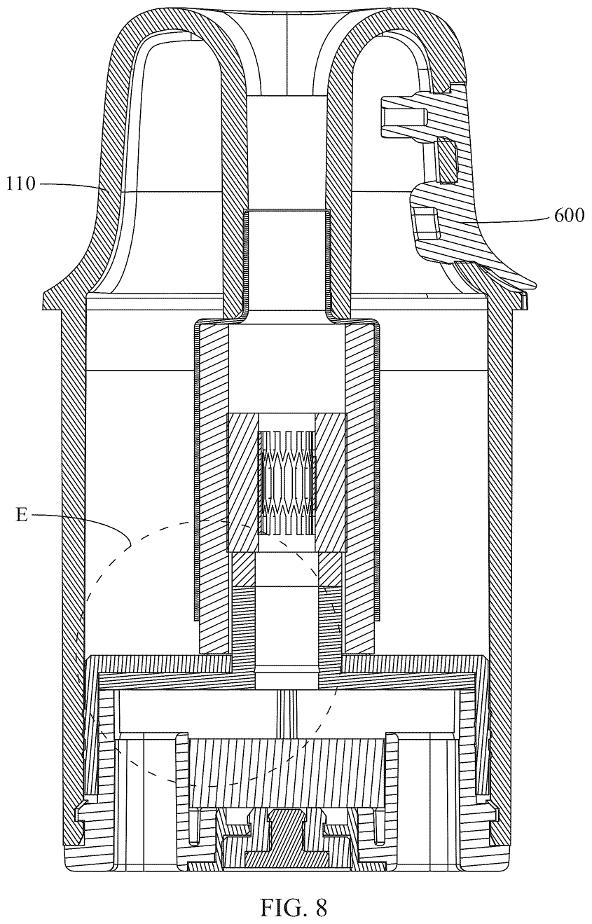

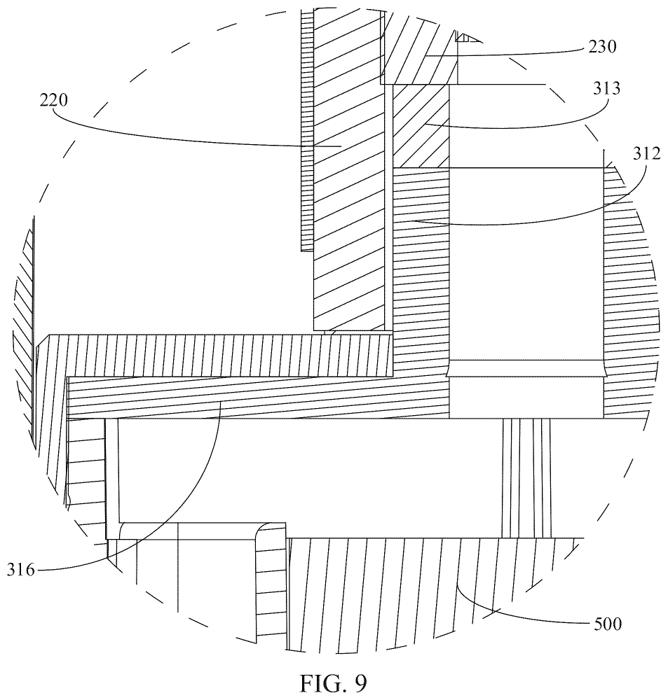

As shown in FIG. 8, in one or more embodiments, the reinforcing sheet 316 surrounds an end of the protrusion 312 away from the mist outlet tube 120, and the protrusion 312 and the reinforcing sheet 316 are integrated. As shown in FIG. 9, the protrusion 312 and the reinforcing sheet 316 are integrated to form a stronger support structure, that is, an end of the atomization assembly 200 close to the base 320 may be fixed, and the support part 314 may be fixed. Each of the protrusion 312 and the reinforcing sheet 316 may adopt a hard material such as plastic or metal (including alloy) to provide a good supporting effect.

As shown in FIG. 8, in one or more embodiments, the side of the support part 314 facing the liquid storage tank 140 is provided with a gas release groove 314a. The gas release groove 314a extends from the connection position between the protrusion 312 and the support part 314 to the liquid storage tank 140 in the radial direction of the protrusion 312 away from the protrusion 312. This is equivalent to connecting the fit clearance between the protrusion 312 and the liquid guide with the liquid storage tank 140, thereby forming a gas passage. When the amount of liquid in the liquid storage tank 140 decreases, the gas may be replenished to the liquid storage tank 140 through the gas passage to balance the gas pressure, so that the liquid in the storage tank 140 is prevented from being unable to flow to the heating part 240 due to excessive negative pressure. For details, please refer to the description of the first gap 312c in the following.

As shown in FIG. 2, in one or more embodiments, an end of the atomization tube 210 facing the base assembly 300 is at least partially spaced apart from the support part 314 to form a liquid inlet 211 for connecting the liquid guide with the liquid storage tank 140. Since the support part 314 is located at the bottom of the liquid storage tank 140, the liquid inlet 211 is provided here to fully utilize the liquid, thereby preventing waste caused by residual liquid in the liquid storage tank 140. Also in another one or more embodiments, as shown in FIG. 1, the heating part 240 is spaced apart from the liquid inlet 211 in the axial direction of the atomization tube 210, and the heating part 240 is higher than the liquid inlet 211 when the atomizer is used by the user. This means that in order for the liquid to reach the heating part 240, it is first necessary for the liquid to climb up to the heating part 240 in the liquid guide against the action of gravity. This weakens the pushing action of a part of the liquid in the liquid storage tank 140 on the liquid in the liquid guide, and prevents leakage caused by the liquid breaking through the surface of the liquid guide due to excessive pressure in the liquid guide. As shown in FIG. 1, the protrusion 312 also blocks the inner peripheral side of the liquid guide, thereby further improving the sealing effect.

As shown in FIG. 1, in one or more embodiments, the height of the inlet 211 starting from the support part 314 in the axial direction of the atomization tube 210 is a. The depth of the protrusion 312 extending into the liquid guide is b. a and b satisfy the constraint 1.5 a≤b≤10 a. When b<1.5 a, the protrusion 312 has a poor effect on supporting the atomization assembly 200, and the atomization assembly 200 is likely to shake, thereby causing leakage. When b>10 a, the heating part 240 is raised too high (because the heating part 240 cannot be shielded by the protrusion 312, but should be exposed in the atomizing passage formed by the protrusion 312, the atomization assembly 200, and the mist outlet tube 120 which are connected) so that the liquid hardly reaches the heating part 240, thereby causing the heating part 240 to dry burn and damage the heating part 240. However, when b is in the above range, the above problems may be overcome.

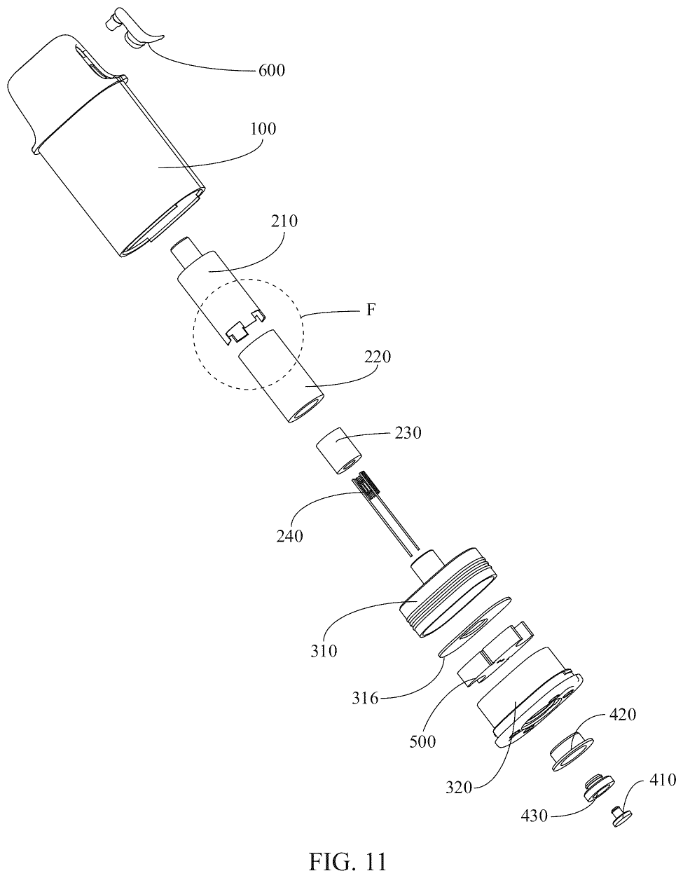

As shown in FIGS. 1 and 11, in one or more embodiments, the atomizer further includes a first electrode 410 and a second electrode 420. The base assembly 300 includes a base 320 and a sealing member 310. The base 320 may be inserted into the installation chamber 130 from the cup mouth, so that the base assembly 300 is connected to the liquid cup 100 by insertion. The sealing member 310 includes a protrusion 312 and a support part 314, and is disposed on the side of the base 320 facing the atomization assembly 200. The first electrode 410 and the second electrode 420 are spaced apart from each other and both extend through the base 320. The protrusion 312 is provided with a lead channel extending through the protrusion 312 in the axial direction of the protrusion 312, and the lead channel may include a first lead channel 312a and a second lead channel 312b. The first electrode 410 may be electrically connected to the heating part 240 through the lead in the first lead channel 312a. The second electrode 420 may be electrically connected to the heating part 240 through the lead in the second lead channel 312b. One of the first electrode 410 and the second electrode 420 may be connected to the positive electrode of the heating part 240, and the other may be connected to the negative electrode of the heating part 240. The first electrode 410 and the second electrode 420 are actually structures of the atomizer electrically connected to the body of the aerosol generating apparatus. Generally, the body extends two contacts (or pins). When the atomizer is connected to the body, the two contacts are in contact with the first electrode 410 and the second electrode 420, respectively, to implement electrical connection. In a general aerosol generating apparatus, the leads of the positive electrode and negative electrode of the heating part 240 are suspended in the mist outlet channel, and are likely to be in contact with each other to cause a short circuit. In one or more embodiments of the present disclosure, the leads of the two electrodes of the heating part 240 are provided in the first lead channel 312a and the second lead channel 312b, respectively, so that it is ensured that the leads are spaced apart from each other and it is not likely to generate a short circuit. In addition, as shown in FIGS. 1 and 11, the first electrode 410 may be an electrode nail, and the second electrode 420 may be an electrode ring. The electrode nail and the electrode ring are separated by an insulating silica gel member 430 to form separate electrodes. Of course, the first electrode 410 and the second electrode 420 may be in the form of general electrodes as long as the first electrode 410 and the second electrode 420 are spaced apart from each other.

As shown in FIG. 6, in one or more embodiments, a glue groove 311 is provided on the side of the sealing member 310 away from the atomization assembly 200. The first lead channel 312a and the second lead channel 312b both extend through the bottom of the glue groove 311. An end of each of the first lead channel 312a and the second lead channel 312b is undoubtedly connected with the liquid guide, since the heating part 240 is provided in the liquid guide. Thus, the liquid may leak along the first lead channel 312a or the second lead channel 312b. Therefore, the glue groove 311 is provided so that a sealant may be filled in the glue groove 311 to block an end of each of the first lead channel 312a and the second lead channel 312b away from the heating part 240 to prevent liquid leakage.

As shown in FIG. 3, in one or more embodiments, the atomizer further includes a liquid absorbing member 500. The liquid absorbing member 500 is disposed on the side of the base 320 facing the protrusion 312 and opposite to the protrusion 312. The liquid absorbing member 500 may adopt a material having a strong adsorption capacity for the liquid, for example, a material similar to the liquid guide. In this way, the liquid falling from the protrusion 312 may be collected into the liquid absorbing member 500, so that the damage to the aerosol generating apparatus due to condensed liquid flowing to the electronic apparatus is prevented.

As shown in FIG. 1, in one or more embodiments, the base assembly 300 includes a sealing member 310 that includes a protrusion 312. The protrusion 312 is disposed facing the atomization assembly 200. As shown in FIG. 1, the protrusion 312 is inserted into an end of the atomization assembly 200 away from the mist outlet tube 120. However, in another one or more embodiments, the protrusion 312 is sleeved on the outer peripheral side of the atomization assembly 200. Both arrangements allow the base assembly 300 to be connected to an end of the atomization assembly 200 away from the mist outlet tube 120 by insertion. The former may block the inner peripheral side of the liquid guide, and the latter may block the fit clearance between the atomization assembly 200 and the base assembly 300. Both may improve sealing.

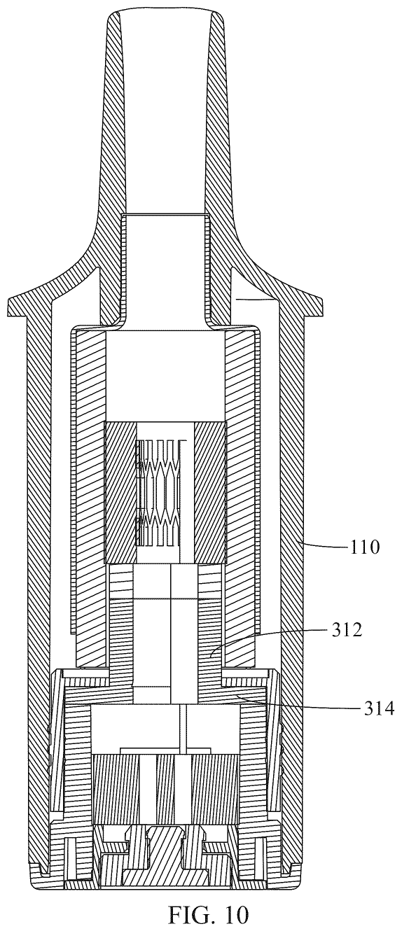

As shown in FIGS. 1 and 10, in one or more embodiments, the atomizer further includes a liquid injection cover 600. The housing 110 is provided with a liquid injection hole connected with the installation chamber 130, and the liquid injection cover 600 covers the liquid injection hole. Thus, when there is insufficient liquid in the liquid storage tank 140, the liquid injection cover 600 may be opened to fill the liquid storage tank 140. This allows the atomizer to be reused. In another one or more embodiments, the atomizer may, of course, not be provided with a liquid injection cover 600, and is a disposable article for ease of use by the user.

In one or more embodiments, the atomization assembly 200 and the base assembly 300 may be first obtained during assembly. The atomizer is in the state shown in FIG. 13, as can be seen that the atomizer includes three modules, that is, the liquid cup 100, the atomization assembly 200 and the base assembly 300. An end of the atomization assembly 200 is connected to the mist outlet tube 120 by insertion. The atomization assembly 200 is connected to the mist outlet tube 120 by insertion. The base assembly 300 is connected to the housing 110 by insertion so as to cover the cup mouth. After the base assembly 300 is connected to the housing 110 by insertion, the base assembly 300 is also naturally connected to the atomization assembly 200 by insertion. It can be seen that due to the modular design, the assembly of the atomizer may be made more convenient.

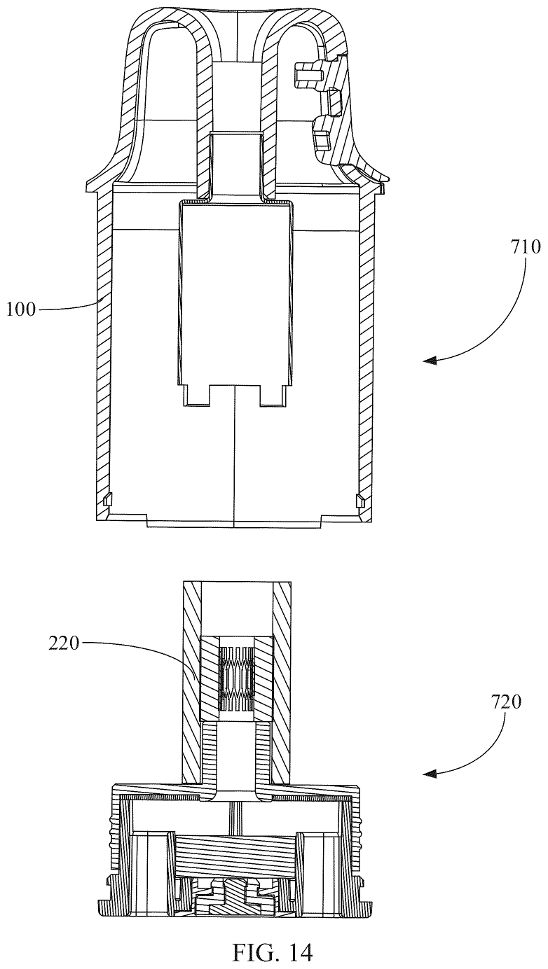

In another one or more embodiments, during assembly, an end of the atomization tube 210 may also be inserted into an end of the mist outlet tube 120 away from the mist outlet 121 to form a first assembly 710, and after the base assembly 300 is assembled, the liquid guide is connected to the base assembly 300 by insertion so as to form a second assembly 720. The atomizer is in the state shown in FIG. 14. The second assembly 720 is inserted into the first assembly 710 from the cup mouth in the axial direction of the atomization tube 210 to complete the assembly of the atomizer. That is, after the second assembly 720 is inserted into the first assembly 710 from the cup mouth, the liquid guide is assembled to the atomization tube 210 while the base assembly 300 is connected to the liquid cup 100 by insertion, so that the assembly is completed. It can be seen that the atomizer may be modularized into the first assembly 710 and the second assembly 720, also with a high degree of modularity, making the assembly of the atomizer more convenient.

As shown in FIG. 1, an atomizer according to one or more embodiments of the present disclosure includes a liquid cup 100, an atomization assembly 200, and a sealing member 310. An end of the liquid cup 100 is provided with a mist outlet 121. In one or more embodiments having a mist outlet tube 120, the mist outlet 121 is provided at an end of the mist outlet tube 120 (see FIG. 1). In one or more embodiments without a mist outlet tube 120, the mist outlet 121 may be served by an installation cup mouth on the housing 110. The atomization assembly 200 includes an atomization tube 210, a liquid guide, and a heating part 240. The heating part 240 is disposed in the liquid guide which is for guiding liquid to the heating part 240. The atomization tube 210 is sleeved at the outer peripheral side of the liquid guide, and is provided with a liquid inlet 211. The atomization tube 210 is connected with the mist outlet 121. The sealing member 310 includes a support part 314 and a protrusion 312. The support part 314 abuts against the inner wall of the liquid cup 100, and the support part 314, the liquid cup 100 and the atomization tube 210 form the liquid storage tank 140. The liquid storage tank 140 is connected with the liquid guide through the liquid inlet 211. The protrusion 312 extends through the support part 314 and extends into the liquid guide from the end of the liquid guide away from the mist outlet 121, so that the protrusion 312, the atomization tube 210 and the mist outlet 121 are connected to form a mist outlet passage. The protrusion 312 at least partially fits the inner wall of the liquid guide and a first gap 312c is formed at the fit position. The first gap 312c may be formed by a clearance fit between the liquid guide and the protrusion 312. However, a gas flow passage may be formed between the liquid guide and the protrusion 312 even when the liquid guide and the protrusion 312 abut against each other. The reason is that the materials of the liquid guide and the protrusion 312 are different, so that the attraction of each of the liquid guide and the protrusion 312 to the liquid is different. When the gas needs to pass through the fit position of the liquid guide and the protrusion 312, since the liquid is subjected to different attractions respectively from the protrusion 312 and the liquid guide, it is likely to be detached from the liquid guide or the protrusion 312 under the influence of the gas, so that a gas passage without liquid is formed in a thin layer on the inner peripheral side of the liquid guide attached to the protrusion 312, that is, the first gap 312c. The liquid guide is at least partially spaced apart from the support part 314 to form a second gap. The first gap 312c is connected with the second gap to form a gas inlet passage connecting the mist outlet passage and the liquid storage tank 140. As shown FIG. 2, the gas may be drawn from the gas passage in the middle of the atomization assembly 200 or the protrusion 312 through gas inlet passage and guided into the liquid storage tank 140. The reason for this design is that the liquid in the liquid storage tank is gradually consumed with the use of the user, so that the space in the liquid storage tank becomes larger. If there is no new gas replenished into the liquid storage tank, the gas volume in the liquid storage tank becomes greater, and the gas pressure decreases. When the gas pressure in the liquid storage tank 140 is less than atmospheric pressure, the gas in the liquid storage tank 140 acts to draw the liquid back into the liquid storage tank, preventing the liquid from being guided to the heating part 240 through the liquid guide. Thus, insufficient liquid guided to the heating part 240 may cause the heating part 240 to overheat and burn out the liquid guide. Therefore, the first gap 312c and the second gap connected with each other are provided, so that the gas can be replenished in the channel liquid storage tank 140 in time, thereby preventing the negative pressure and improving the liquid supply capacity of the atomizer.

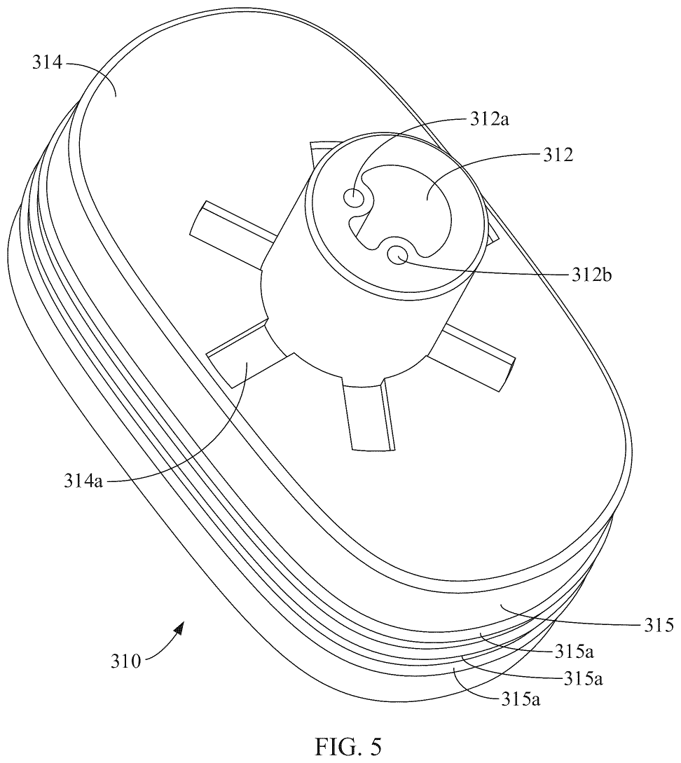

As shown in FIG. 5, in one or more embodiments, an end face of the liquid guide facing the support part 314 abuts against the support part 314. In this way, the support part 314 may provide support for the liquid guide and improve the stability of the liquid guide. A gas release groove 314a is provided on a side of the support part 314 facing the liquid guide to form a second gap. This also ensures the formation of the second gap and the liquid supply capacity of the aerosol generating apparatus.

As shown in FIG. 4, in one or more embodiments, the gas release groove 314a extends in the radial direction of the protrusion 312. The atomization tube 210 has a projection on the sealing member, and the gas release groove 314a protrudes out of the projection in the radial direction of the protrusion 312. As can be seen in FIG. 4, a projection of the protrusion 312 in an axial direction on the support part 314 does not cover the gas release groove 314a, which ensures that the gas release groove 314a has an enough length and there is an enough vent length enable the gas to enter the liquid storage tank 140 smoothly.

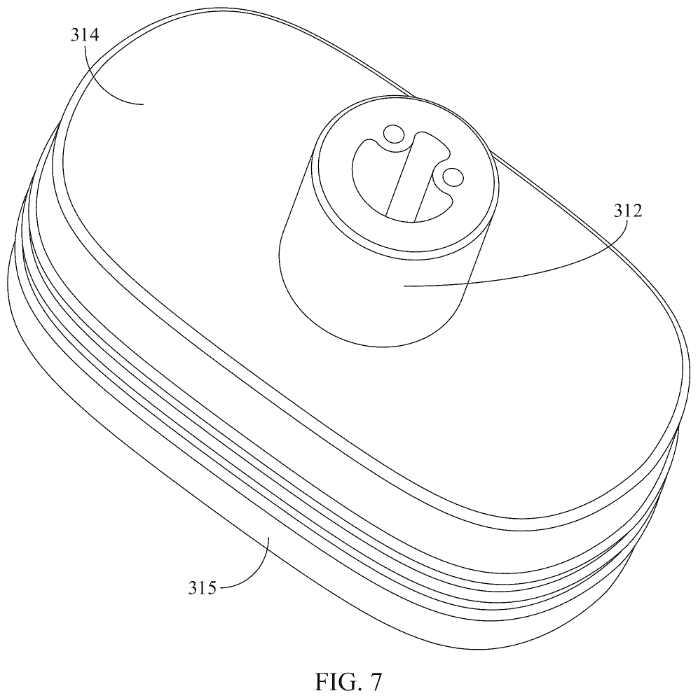

As shown in FIG. 5, in one or more embodiments, there are multiple gas release grooves 314a, which are arranged at equal intervals in the circumferential direction of the protrusion 312. In this way, during the use of the atomizer, although the user may use the atomizer at various angles, there is at least one of the gas release grooves 314a at each angle to ensure the stability of the use of the atomizer. The effect of gas release is prevented from being poor at some angles. However, as shown in FIG. 7, in one or more embodiments, the gas release groove 314a may not be provided, and the support part 314 and the end face of the liquid guide close to the support part 314 may be spaced apart from each other, thereby forming the second gap.

As shown in FIGS. 1 and 2, in one or more embodiments, the liquid guide includes a first liquid guide 220 and a second liquid guide 230. The atomization tube 210 is sleeved on the outer peripheral side of the first liquid guide 220. The first liquid guide 220 is sleeved on the outer peripheral side of the second guide 230. The heating part 240 is disposed in the second liquid guide 230. The radially outer peripheral side of the protrusion 312 fits the radially inner peripheral side of the first liquid guide 220 to form the first gap 312c. The end face of the protrusion 312 away from the support part 314 fits the end face of the second liquid guide 230 to form a third gap, which is connected with the first gap 312c. The principle in which the protrusion 312 fits the first liquid guide 220 to form the first gap 312c is the same as that in which the protrusion 312 fits the liquid guide to form the first gap 312c, which is not repeated. The principle of forming the third gap may be the same as that of forming the first gap 312c. However, a gas groove extending radially along the second protrusion 312 may be provided on the end face of the protrusion 312 facing the second liquid guide 230, and the gas groove connects the gas passage in the protrusion 312 with the first gap 312c, so that the third gap is formed by the gas groove. The arrangement of the third gap may improve the gas inlet effect of the gas inlet passage into the liquid storage tank 140.

As shown in FIG. 1, in one or more embodiments, the sealing member 310 further includes a first extension part 315. The first extension part 315 is provided on the peripheral side of the support part 314 and extends away from the liquid storage tank 140. This is equivalent to providing the support part 314 with a skirt. The outer peripheral side of the first extension part 315 abuts against the inner wall of the liquid cup 100. This is equivalent to expanding the contact area between the support part 314 and the inner wall of the liquid cup 100, so that when the liquid penetrates into the fit clearance between the support part 314 and the liquid cup 100 and the support part 314 is broken through, the first extension part 315 further generates a sealing effect, thereby preventing the leakage of the liquid and improving the sealing effect.

As shown in FIG. 5, in one or more embodiments, the outer peripheral side of the first extension part 315 is provided with a protruding rib 315a, which extends in the circumferential direction of the first extension part 315 and surrounds the first extension part 315. Thus, when the outer peripheral side of the first extension part 315 abuts against the inner wall of the liquid cup 100, the protruding rib 315a also abuts against the inner wall of the liquid cup 100. However, since the protruding rib 315a protrudes out of the first extension part 315 in the radial direction of the first extension part 315, the pressure between the protruding rib 315a and the liquid cup 100 may be greater than the pressure between another portion of the first extension part 315 and the liquid cup 100. This allows the protruding rib 315a to better seal the fit clearance between the first extension part 315 and the cup 100, thereby improving the sealing effect.

As shown in FIG. 9, in one or more embodiments, the liquid guide includes the first liquid guide 220 and the second liquid guide 230. The atomization tube 210 is sleeved on the outer peripheral side of the first liquid guide 220. The first liquid guide 220 is sleeved on the outer peripheral side of the second guide 230. The heating part 240 is disposed in the second liquid guide 230. The radially outer peripheral side of the protrusion 312 fits the radially inner peripheral side of the first liquid guide 220 to form the first gap 312c. The end face of the protrusion 312 away from the support part 314 fits the end face of the second liquid guide 230 to form a third gap. The sealing member 310 also includes a heat insulation sleeve 313 which is sleeved at the end of the protrusion 312 close to the second liquid guide 230. As shown in FIG. 8 or FIG. 9, in one or more embodiments, the protrusion 312 and the reinforcing sheet 316 are integrated. Thus, the protrusion 312 has the same material as the reinforcing sheet 316, and may has a plastic having a low heat resistance. Therefore, the heat insulation sleeve 313 is provided to better separate the protrusion 312 from the heating part, so that the protrusion 312 may be protected. As shown in FIG. 10, the heat insulation sleeve 313 may also extend toward the base 320 in the axial direction of the protrusion 312. In this way, a first lead channel 312a and a second lead channel 312b may be provided in the heat insulation sleeve 313. It will be readily appreciated that, as shown in FIG. 1, the end of the protrusion 312 is not provided with the heat insulation sleeve 313, while as shown in FIG. 9, the end of the protrusion 312 close to the second liquid guide 230 is sleeved with the heat insulation sleeve 313.

As shown in FIG. 1 or FIG. 11, in one or more embodiments, the atomizer further includes a liquid injection cover 600. The wall of the liquid cup 100 is further provided with a liquid injection hole connected with the liquid storage tank 140, and the liquid injection cover 600 covers the liquid injection hole. Thus, when there is not sufficient liquid in the liquid storage tank 140, the liquid injection cover 600 may be opened to fill the liquid storage tank 140, which allows the atomizer to be reused.

As shown in FIG. 1, in one or more embodiments, the liquid injection hole is spaced apart from the second gap in the axial direction of the atomization assembly 200. In this way, when the liquid is filled, it is not easy for the liquid to directly flush into the second gap, which causes the liquid to flow from the second gap into the first gap 312c, and finally flow into the gas passage in the atomization assembly 200, thereby causing leakage of the liquid.

In the above-mentioned embodiments, the description of each embodiment has its own emphasis. For a part not described in detail in a certain embodiment, the related description in other embodiments may be referred to.

In the description of the present disclosure, the terms “first” and “second” are used for descriptive purposes only and are not to be construed as indicating or implying relative importance or implying the number of indicated technical features. Thus, a feature defined as “first” or “second” may explicitly or implicitly include one or more features.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. An atomizer, comprising:
a liquid cup having a first end provided with a cup mouth and a second end provided with a mist outlet, wherein the first end is opposite to the second end, and a liquid storage tank is provided in the liquid cup;
an atomization assembly comprising an atomization tube, a liquid guide part, and a heating part disposed inside the liquid guide part, the atomization tube being sleeved on an outer peripheral side of the liquid guide part and connected with the mist outlet, the atomization tube being provided with one or more liquid inlets so that the liquid guide part is connected with the liquid storage tank; and
a base assembly comprising a base and a sealing member mounted on the base, the sealing member comprising a protrusion extending toward the mist outlet to be inserted into an end of the liquid guide part away from the mist outlet, the sealing member fitting with at least part of an inner wall of the liquid guide part to seal an inner side of the liquid guide part.

2. The atomizer of claim 1, wherein the sealing member further comprises a support part connected to the protrusion, and the support part is mounted on the base and abuts against an inner wall of the liquid cup so that the support part, the liquid cup and the atomization tube form the liquid storage tank.

3. The atomizer of claim 2, wherein in an axial direction of the atomization tube, each of the liquid inlets has a height a from the support part and the protrusion has a depth b extending into the liquid guide part; and
1.5 a≤b≤10 a.

4. The atomizer of claim 3, wherein the one or more liquid inlets comprise a plurality of liquid inlets arranged at equal intervals in a circumferential direction of the atomization tube; and
an end of the atomization tube close to the support part is provided with a plurality of abutments each protruding in an axial direction of the atomization tube and abutting against the support part, and the plurality of abutments are arranged at intervals to form the plurality of liquid inlets.

5. The atomizer of claim 3, wherein the one or more liquid inlets comprise one liquid inlet; and
an end of the atomization tube close to the support part is spaced apart from the support part to form the one liquid inlet.

6. The atomizer of claim 3, wherein the sealing member further comprises a first extension part surrounding the support part and extending away from the liquid storage tank, and an outer peripheral side of the first extension part abuts against the inner wall of the liquid cup.

7. The atomizer of claim 6, wherein the sealing member further comprises a reinforcing sheet attached to a side of the support part away from the liquid storage tank to support the support part.

8. The atomizer of claim 7, wherein the protrusion extends through the reinforcing sheet and protrudes from a side of the reinforcing sheet away from the support part.

9. The atomizer of claim 7, wherein the base comprises a cover covering the cup mouth, and a second extension part surrounding the cover and extending toward the support part; and
an outer peripheral side of the second extension part abuts against the first extension part, and/or an end face of the second extension part away from the cover abuts against the reinforcing sheet.

10. The atomizer of claim 9, further comprising a liquid absorbing member disposed on a side of the cover facing the protrusion to be opposite to the protrusion.

11. The atomizer of claim 10, further comprising a first electrode and a second electrode spaced apart from each other,
wherein each of the first electrode and the second electrode penetrates the cover;
the protrusion is provided with a first lead channel and a second lead channel each extending through the protrusion in an axial direction of the protrusion; and
the first electrode is electrically connected to the heating part through the first lead channel, and the second electrode is electrically connected to the heating part through the second lead channel.

12. The atomizer of claim 2, wherein a side of the support part facing the liquid storage tank is provided with a gas release groove extending, from a connection point between the protrusion and the support part, away from the protrusion in a radial direction of the protrusion; and
the gas release groove is connected with the liquid storage tank.

13. The atomizer of claim 1, wherein a wall of the liquid cup is provided with a liquid injection hole connected with the liquid storage tank; and
the atomizer further comprises a liquid injection cover covering the liquid injection hole.

14. The atomizer of claim 2, wherein the liquid guide part comprises a first liquid guide and a second liquid guide;
the atomization tube is sleeved on an outer peripheral side of the first liquid guide;
the first liquid guide is sleeved on an outer peripheral side of the second liquid guide;
the heating part is disposed in the second liquid guide;
an outer peripheral side of the protrusion abuts against an inner peripheral side of the first liquid guide; and
an end face of the protrusion away from the support part abuts against an end face of the second liquid guide.

15. The atomizer of claim 1, wherein the protrusion is provided with a gas flow passage connecting with an outside.

16. An aerosol generating apparatus, comprising a body and an atomizer connected to the body,
wherein the atomizer comprises:
a liquid cup having a first end provided with a cup mouth and a second end provided with a mist outlet, wherein the first end is opposite to the second end, and a liquid storage tank is provided in the liquid cup;
an atomization assembly comprising an atomization tube, a liquid guide part, and a heating part disposed inside the liquid guide part, the atomization tube being sleeved on an outer peripheral side of the liquid guide part and connected with the mist outlet, the atomization tube being provided with one or more liquid inlets so that the liquid guide part is connected with the liquid storage tank; and
a base assembly comprising a base and a sealing member mounted on the base, the sealing member comprising a protrusion extending toward the mist outlet to be inserted into an end of the liquid guide part away from the mist outlet, the sealing member fitting with at least part of an inner wall of the liquid guide part to seal an inner side of the liquid guide part.

17. The aerosol generating apparatus of claim 16, wherein the sealing member further comprises a support part connected to the protrusion, and the support part is mounted on the base and abuts against an inner wall of the liquid cup so that the support part, the liquid cup and the atomization tube form the liquid storage tank.

18. The aerosol generating apparatus of claim 17, wherein in an axial direction of the atomization tube, each of the liquid inlets has a height a from the support part and the protrusion has a depth b extending into the liquid guide part; and
1.5 a≤b≤10 a.

19. The aerosol generating apparatus of claim 18, wherein the one or more liquid inlets comprise a plurality of liquid inlets arranged at equal intervals in a circumferential direction of the atomization tube; and
an end of the atomization tube close to the support part is provided with a plurality of abutments each protruding in an axial direction of the atomization tube and abutting against the support part, and the plurality of abutments are arranged at intervals to form the plurality of liquid inlets.

20. The aerosol generating apparatus of claim 18, wherein the one or more liquid inlets comprise one liquid inlet; and
an end of the atomization tube close to the support part is spaced apart from the support part to form the one liquid inlet.
